(19) United States
(12) Patent Application Publication
(10) Pub. No.: US 2016/0211742 A1
(43) Pub. Date: Jul. 21, 2016

(54) Autonomous Multi-Source Energy Harvesting System

(71) Applicant: Khalifa University of Science, Technology & Research (KUSTAR), Abu Dhabi (AE)

(72) Inventors: Baker Mohammad, Abu Dhabi (AE); Mohammad Al Hawari, Abu Dhabi (AE); Maisam Wahbah, Abu Dhabi (AE); Mohammed Ismail Elnaggar, Abu Dhabi (AE)

(21) Appl. No.: 14/601,816

(22) Filed: Jan. 21, 2015

(51) Int. Cl. H02M 1/36

(52) U.S. Cl. CPC H02M 1/36

(57) ABSTRACT

There is provided a self-powered energy harvesting system for harvesting electrical energy from the environment for feeding a load, the system comprising a first energy harvester for generating first electrical energy having a first input voltage from the environment; a first local storage unit for storing the first electrical energy after conversion; a passive startup circuit connected to the first energy harvester for harvesting, converting and storing the first electrical energy inside the first local storage unit; a second energy harvester for generating second electrical energy having a second input voltage from the environment; and an active circuit connected to the first local storage unit, to the second energy harvester and to the load for extracting and using the first electrical energy stored in the first local storage unit for harvesting, converting and directing the second electrical energy to the load, the second input voltage being insufficient for operating the active circuit. There is also provided a passive startup circuit and an energy-aware time multiplexer for combining energy originating from the different energy harvesting sources for use with energy harvesting systems.

### FIELD OF THE INVENTION

The present invention relates generally to the field of energy harvesting from ambient sources of the environment, and more particularly to a self-powered energy harvesting system, a passive startup circuit and an energy-aware time-multiplexer for use with energy harvesting systems.

### BACKGROUND OF THE INVENTION

Energy harvesting from ambient sources such as vibration, wireless, thermal, and solar are important step to enable new class of electronics system that can be used in biomedical application or for sensing the environment. The demand for battery free operation is also important for medical devices or hard-to-reach places such as smart building or ocean sensing.

One challenge with existing systems that utilize energy harvesting is the need for start-up mechanism that is required to enable the conversion circuit. The startup circuit is needed for the thermal energy harvesting because of the extremely output voltage generated when used in human body based harvesting application. For nominal temperature difference between the skin and the ambient temperature (2C), the output voltage reaches around 50 mV. Such voltage is low enough that can't initiate the converter circuit.

Another challenge with the existing system is the inefficient combination of energy originating from multiple energy sources. Multiple-sources energy combiner was reported in the literature however leading to drawbacks. For example, one traditional technique is to combine the power generated from an RF and Thermal harvesters by connecting the harvester that has the higher instantaneous power (see H. Lhermet, et al, “Efficient power management circuit: From thermal energy harvesting to above-ic microbattery energy storage,” JSSC, vol. 43, no. 1, pp. 246-255,2008). This technique would result in a loss in efficiency due to the idle state. Another traditional technique is to stack multiple individual storage capacitors to add the output voltage from solar and piezoelectric harvesters (see J. Guilar, R. Amirtharajah, P. J. Hurst, and S. H. Lewis, “An energyaware multiple-input power supply with charge recovery for energy harvesting applications,” in IEEE ISSCC Dig. Tech. Papers, Feb. 2009, pp. 298-299). This would also result in inefficient use of energy. Another known technique is to use a time multiplexing scheme for three power sources namely, thermal, Piezo and solar, by giving a time slot for each harvester so that energy can be extracted from that harvester and stored in a global super capacitor (see Bandyopadhyay, S.; Chandrakasan, A. P., “Platform Architecture for Solar, Thermal, and Vibration Energy Combining With MPPT and Single Inductor,” Solid-State Circuits, IEEE Journal of , vol.47, no.9, pp.2199,2215, September 2012). The problem with this technique is that it will lead also to inefficient use of energy when at least one of the harvesters is not available at the allocated time slot. In fact, this would result to consuming energy by the energy combiner while not harvesting any energy in return. Also, since the global capacitor would be connected to the unavailable harvester, this would discharge the global capacitor because the unavailable harvester would act as a ground.

### SUMMARY OF THE INVENTION

The present invention aims to overcome the above mentioned limitations and other drawbacks associated with the prior art.

As a first aspect of the invention, there is provided a self-powered energy harvesting system for harvesting electrical energy from the environment for feeding a load, the system comprising:
a first energy harvester for generating first electrical energy having a first input voltage from the environment;
a first local storage unit for storing the first electrical energy;
a passive startup circuit connected to the first energy harvester for harvesting and storing the first electrical energy inside the first local storage unit;
a second energy harvester for generating second electrical energy having a second input voltage from the environment; and
an active circuit connected to the first local storage unit, to the second energy harvester and to the load for extracting and using the first electrical energy stored in the first local storage unit for harvesting, converting and directing the second electrical energy to the load, the second input voltage being insufficient for operating the active circuit.

Preferably, the energy harvesting system further comprises a control circuit connected to the first local storage unit, to the passive startup circuit and to the active circuit for determining whether the first electrical energy stored inside the first local storage unit is sufficient for operating the active circuit and if it is the case, for deactivating the passive startup circuit and activating the active circuit.

Preferably, the passive startup circuit comprises:
a normally on switch connected to the first energy harvester and to the control circuit for switching off the passive startup circuit when instructed by the control circuit.

Preferably, the energy harvesting system further comprises a second local storage unit for storing the second electrical energy after electrical conversion into a suitable electrical form for storage.

Preferably, the first and second local storage units are electrical capacitors. However, they can also be batteries.

Preferably, the active circuit is further connected to the second energy harvester for harvesting, converting and storing the second electrical energy inside the second local storage unit when the startup circuit is switched off and for directing the second electrical energy to the load.

Preferably, the first energy harvester comprises a vibration harvester and wherein the passive startup circuit further comprises a low efficiency AC-DC converter connected to the vibration harvester through the normally on switch for converting the first electrical energy originating from the vibration harvester before storage in the first local storage unit.

In an embodiment of the invention, the first energy harvester further comprises a solar harvester connected to the first local storage unit for storing the first electrical energy originating from the solar harvester in the first local storage unit without prior conversion. In an embodiment, the solar harvester need not to be connected to a low-efficiency DC-DC converter as the electrical energy generated by the solar harvester is already in suitable form for storage in the local storage unit without conversion. However, in another embodiment, the passive startup circuit further comprises a low efficiency DC-DC converter connected to the solar harvester for converting the electrical energy originating therefrom before storage in the first local storage unit.

Preferably, the low-efficiency electrical converter comprises a capacitor at its output.

Preferably, the second energy harvester comprises a thermal harvester and the active circuit comprises a high-efficiency DC-DC converter connected to the second energy harvester and to the second local storage unit for converting the second electrical energy before storage.

Preferably, the energy harvesting system further comprises:
a global storage unit; and
an energy combiner connected to the first local storage unit, to the second local storage unit, to the global storage unit and to the first and second energy harvesters for monitoring the first and second input voltages, for determining availability of the first and second electrical energy based on the monitoring, for extracting any available electrical energy among the first and second electrical energy from the first and second local storage units based on the energy availability determination, and for directing the extracted electrical energy for storage inside the global energy storage unit.

Preferably, the energy combiner comprises:
a switching control logic circuit connected to the energy harvesters for monitoring the first and second input voltages and for determining the availability of the first and second electrical energy, the monitoring and the energy availability determination comprising comparing the first and second input voltages to a threshold voltage and making the determination based on the comparison;
a switch matrix circuit connected to the switching control logic circuit, to the first and second local storage units and the global storage unit for receiving an indication of the available electrical energy among the first and second electrical energy from the switching control local circuit and for extracting and directing the available electrical energy from the first and second local storage units to the global energy storage unit on a time slot allocation basis as a function of the received indication.

Preferably, the global energy storage unit comprises a supercapacitor or a battery.

Preferably, the energy harvesting system further comprises a power management unit for converting and directing the electrical energy stored in the global storage unit to the load.

Preferably, the load comprises a plurality of loads and the power management unit comprises a plurality of electrical DC-DC converters adapted for the plurality of loads and a power gating technique connected between the plurality of DC-DC converters and the plurality of loads.

As another aspect of the invention, there is provided a passive startup circuit for use with an energy harvesting system comprising an active circuit for harvesting electrical energy from a low power energy harvester generating a low voltage input voltage insufficient for an autonomous operation of the active circuit, the passive startup circuit comprising:
a high power energy harvester for generating first electrical energy from the environment;
a first local storage unit for storing the first electrical energy;
a control circuit connected to the first local storage unit, to the passive startup circuit and to the active circuit for determining whether the first electrical energy stored inside the first local storage unit is sufficient for operating the active circuit and if it is the case, for deactivating the passive startup circuit and activating the active circuit; and
a normally on switch connected to the first energy harvester, to the low-efficiency electrical converter and to the control circuit for switching off the passive startup circuit when instructed by the control circuit.

Preferably, the first local storage unit comprises an electrical capacitor. However, the first local storage unit can alternatively comprise a battery.

Preferably, the low-efficiency electrical converter comprises a capacitor at its output.

Preferably, the high power energy harvester comprises a vibration harvester and wherein the passive startup circuit further comprises a low efficiency AC-DC converter connected to the vibration harvester through the normally on switch for converting the first electrical energy originating from the vibration harvester before storage in the first local storage unit..

In an embodiment of the invention, the high power energy harvester further comprises a solar harvester connected to the first local storage unit for storing the first electrical energy originating from the solar harvester in the first local storage unit without prior conversion. In an embodiment, the solar harvester need not to be connected to a low-efficiency DC-DC converter as the electrical energy generated by the solar harvester is already in suitable form for storage in the local storage unit without conversion. However, in another embodiment, the passive startup circuit further comprises a low efficiency DC-DC converter connected to the solar harvester for converting the electrical energy originating therefrom before storage in the first local storage unit.

Preferably, the low power energy harvester comprises a thermal harvester.

The passive startup circuit can function with an energy harvesting system according to any embodiment of the present invention.

As a further aspect of the invention, there is provided an energy combiner for use with an energy harvesting system harvesting electrical energy using at least two energy harvesters, a first energy harvester having a first input voltage generating a first electrical energy and a second energy harvester having a second input voltage generating a second electrical energy, wherein:
the energy combiner is adapted to be connected to the first and second energy harvesters for monitoring the first and second input voltages, for determining availability of the first and second electrical energy based on the monitoring, for harvesting any available electrical energy among the first and second electrical energy selectively based on the energy availability determination, and for storing the harvested electrical energy inside a global energy storage unit for subsequent use by the energy harvesting system.

Preferably, the energy combiner comprises:
a switching control logic circuit connected to the energy harvesters for monitoring the first and second input voltages and for determining the availability of the first and second electrical energy, the monitoring and the energy availability determination comprising comparing the first and second input voltages to a threshold voltage and making the determination based on the comparison;
a switch matrix circuit connected to the switching control logic circuit, to the first and second electrical energy for receiving an indication of the available electrical energy among the first and second electrical energy from the switching control logic circuit and for harvesting and directing the available electrical energy to the global energy storage unit on a time slot allocation basis as a function of the received indication.

The energy combiner can also function with an energy harvesting system according to any embodiment of the present invention.

In order to overcome the limitations associated with the energy combiner, there is provided an energy-aware time multiplexing combiner adapted to monitor the amount of energy available at the harvesters and to allocate the time slots for these harvesters based on the amount of energy available.

### BRIEF DESCRIPTION OF THE DRAWINGS

FIG. 1 shows the overall structure of the energy harvesting system in accordance with a preferred embodiment of the invention;

FIG. 2 a) shows a startup circuit of the energy harvesting system in accordance with one embodiment of the invention;

FIG. 2 b) shows a startup circuit of the energy harvesting system in accordance with another embodiment of the invention;

FIG. 3 a) shows a startup circuit (passive circuit) and a normal operation circuit (active circuit) of the energy harvesting system in accordance with one embodiment of the invention;

FIG. 3 b) shows a startup circuit (passive circuit) and a normal operation circuit (active circuit) of the energy harvesting system in accordance with another embodiment of the invention;

FIG. 4 a) shows the energy combiner with an energy-aware time multiplexing scheme in accordance with a preferred embodiment of the invention;

FIG. 4 b) shows an example of operation of the energy combiner where energy is available from three energy harvesting sources, solar, thermal and vibration;

FIG. 4 c) shows an example of operation of the energy combiner where energy is available from only the thermal and vibration energy harvesting sources and where the solar harvester is not available; and

FIG. 5 shows the power management unit of the energy harvesting system in accordance with a preferred embodiment of the invention.

### DETAILED DESCRIPTION OF THE INVENTION

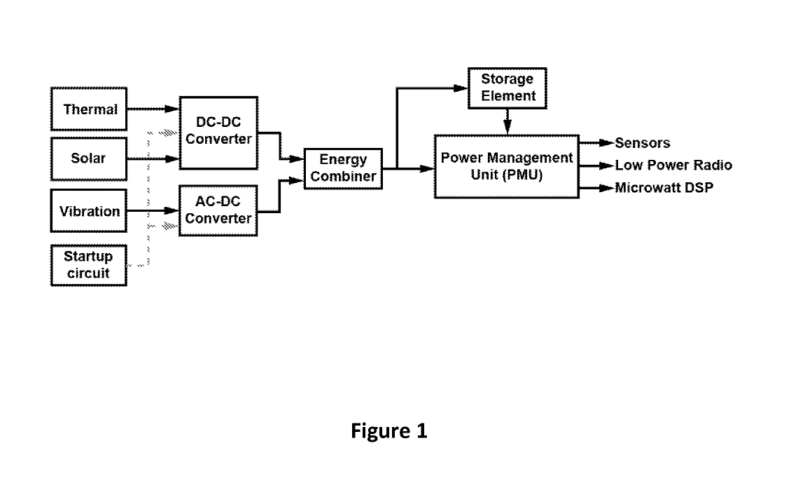

As illustrated in FIG. 1, there is provided an autonomous self-powered multi-source energy harvesting system 1 adapted to harvest energy from different energy sources from the environment including solar, thermal and vibration. The harvesting system 1 is adapted to be autonomous in the sense that it does not require a battery to start up the energy harvesting mechanism to harvest the different energy sources. The harvesting system 1 can be used in a wide range of applications including but not limited to health monitoring, industrial automation, smart buildings, and in remote locations where battery replacement is challenging or impossible.

The autonomous multi-source energy harvesting system 1 comprises multiple energy harvesters of different types. Three types of energy harvesters will be illustrated in this application, knowingly thermal, solar and vibration, however it should be understood that other types of energy sources can be used. In our example, autonomous multi-source energy harvesting system 1 comprises a vibration energy harvester 2, a solar energy harvester 4, and a thermal energy harvester 6 for respectively harvesting vibration energy, solar energy and thermal energy. The harvesting system 1 further comprises a passive startup circuit 5 in electrical communication with at least one of the vibration energy harvester 2 and the solar energy harvester 4. The startup circuit 5 uses high output voltage energy harvesters such as the piezoelectric energy harvester 2 and/or the solar energy harvester 4 as a startup circuit for kicking off the energy harvesting system 1. The energy harvesting system 1 also uses other low voltage output energy harvesters such as the thermal energy harvester 6 as a power source during the normal operation of the system 1 in addition to the other high voltage output energy harvesters. Other types of energy harvesters can also be used.

The startup circuit 5 is adapted to operate in the beginning and for a short period of time. The startup circuit 5 uses a passive low-efficiency converter circuit to collect sufficient energy to jump-start the system 1. Once sufficient energy is collected, the passive startup circuit 5 is turned off from operation.

In fact, piezoelectric can provide 3-10V open circuit voltage while solar energy can give 0.2-0.9V. This range of voltage output is sufficient to run the passive startup circuit 5 and to accumulate energy in order to operate the harvesting system 1. Other types of energy harvesters can also be used for the startup mechanism provided they do not require energy to operate and they produce a sufficient amount of output voltage for operating the system 1. Once sufficient energy is harvested using the startup circuit 5, other energy sources, such as thermal, can be used to collect energy using the active circuit of the system 1. As such, depending on the application, different energy harvesting sources can be utilized for startup and harvesting at the same time.

As illustrated in FIG. 1, the energy harvesting system 1 further comprises AC-DC converters 7 and DC-DC converters 9 for converting the electrical energy received from the energy harvesters 2, 4 & 6 into suitable form of electrical energy for purposes of combination and further storage. In an embodiment of the invention, the AC-DC converters 7 comprise at least one low-efficiency AC-DC converter 10 and at least one high-efficiency AC-DC converter 16. In an embodiment of the invention, the DC-DC converters 9 comprise at least one low-efficiency DC-DC converter 14 and at least one high-efficiency DC-DC converter 18 & 20.

The AC-DC converters 7 are in electrical communication with the energy harvesters generating AC current, such as the vibration harvester 2. The DC-DC converters 9 are in electrical communication with the energy harvesters generating DC current, such as the thermal harvester 6 and the solar harvester 4 (optionally). In an embodiment of the invention, the solar harvester 4 is directly connected to the local storage unit 24 without passing through a low efficiency DC-DC converter 14 as the electrical energy generated by the solar harvester 4 need not to be converted before storage. Therefore, depending on the application, the low efficiency DC-DC converter 14 might not be needed. The low efficiency AC-DC converter 10 and the low efficiency DC-DC converter 14 (when it is the case) are only in operation during the startup phase while the passive startup circuit 5 is in operation. Once sufficient energy is collected by the startup circuit 5 for operating the harvesting system, the startup circuit 5 is turned off and these low efficiency converters 10 & 14 are not in operation. From another side, the high efficiency AC-DC converter 16 and DC-DC converter 18 & 20 are in operation once sufficient energy is collected by the startup circuit 5 for operating the harvesting system 1 and the startup circuit 5 is off. At the normal operational phase of the system 1, the active electronic components of the harvesting system 1 are in operation for harvesting the different energy harvesters 2, 4 & 6 comprising receiving electrical energy produced by these harvesters 2, 4 & 6, converting the electrical energy received into a suitable form of energy for operation of the active electronic components of the system 1, combining the electrical energy received and converted from the different energy harvesters 2, 4 & 6 in an energy efficient manner, and storing the electrical energy combined for subsequent use depending on the application.

The energy harvesting system 1 further comprises an energy combiner 25 in electrical communication with the AC-DC converters 7 and with the DC-DC converters 9 for receiving the transformed electrical energy originating from the different energy harvesters 2, 4 & 6 and for combining and storing the electrical energy inside the storage element 40. The energy combiner 25 is an intelligent energy-aware combiner adapted to combine energy originating from the different energy harvesters 2, 4 & 6 with minimum energy loss. The energy combiner 25 is an essential component in the multiple-sources energy harvesting system 1 because the generated energy from different energy sources 2, 4 & 6 needs to be combined, delivered and stored in one global storage element 40 that is shared between all energy sources 2, 4 & 6 without (or with minimum) efficiency loss.

The harvesting system 1 further comprises a power management unit 45 in electrical communication with the storage element 40 for delivering the necessary voltage level to different loads 54, 56, 58 & 60 such as sensors, low power radio and microwatt DSP. The different loads can vary based on the applications desired. The power management unit 45 comprises DC-DC converters in electrical communication with the global storage unit 40 for converting the energy stored in the global storage unit 40 into suitable forms required by the loads 54, 56, 58 & 60. The power management unit 45 further comprises a power gating technique 50 in electrical communication with the DC-DC converters 42, 44 & 46 and the loads 54, 56, 58 & 60 for distributing electrical energy to these loads based on their respective energy requirements.

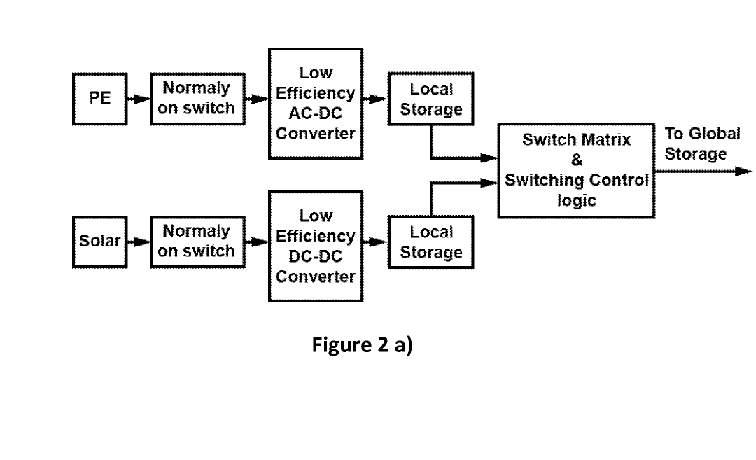

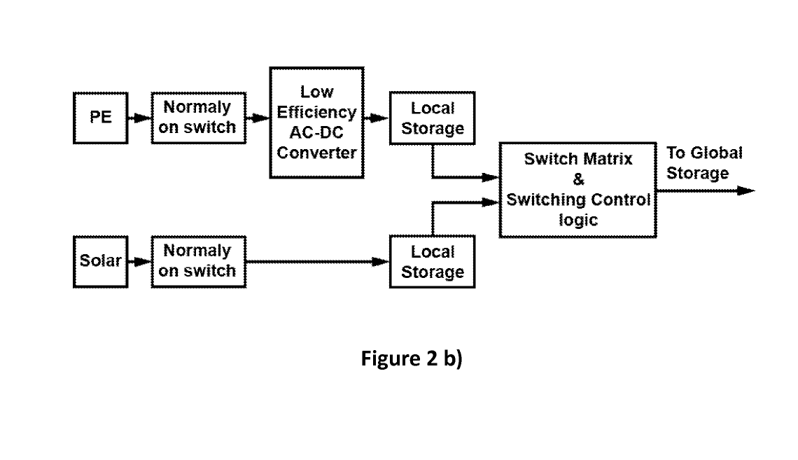

Referring to FIG. 2, the startup circuit 5 comprises a first normally on switch 8 in electrical communication with the vibration harvester 6 and a second normally on switch 8 in electrical communication with the solar harvester 4. According to FIG. 2 a), the normally on switches 8 & 12 are also in electrical communication with the low efficiency AC-DC converter 10 and the low efficiency DC-DC converter 14 for transferring the electrical energy from the vibration harvester 6 and the solar harvester 4 respectively while these switches 8 & 12 are in open position. These switches 8 & 12 are in open position only when the harvesting system 1 does not have sufficient energy for operating the active components of the system 1 (also named the active circuit). The low efficiency AC-DC converter 10 and the low efficiency DC-DC converter 14 are respectively in electrical communication with local storage units 22 & 24 for storing the collected energy individually in these local storage units 22 & 24 respectively. FIG. 2 b) shows a startup circuit 5 without a low efficiency DC-DC converter where the electrical energy generated by the solar harvester 4 is directed to the local storage unit 24 without prior conversion. In fact, in an embodiment of the invention, the electrical energy originating from the solar harvester 4 need not to be converted and therefore it is more efficient to have it stored directly in the local storage unit 24 without passing through a converter.

When the harvesting system 1 has sufficient energy collected to operate the active components, the switches 8 & 12 are turned off. The switches 8 & 12 are in electrical communication with a control circuit 28 for controlling their operation. The control circuit 28 is also in electrical communication with the local storage units 22 & 24 as well as with the global storage unit 40 for making the determination on whether the system 1 has sufficient energy to operate and whether the startup circuit 5 needs to shut off. If it is the case and the system 1 has sufficient energy collected to operate the active circuit of the system 1, then the control circuit 28 turns off the normally on switches 8 & 12. At this stage, the active circuit of the system 1 starts operating for harvesting the energy harvesters 2, 4 & 6 and combining and storing their respective energy inside the global storage unit 40.

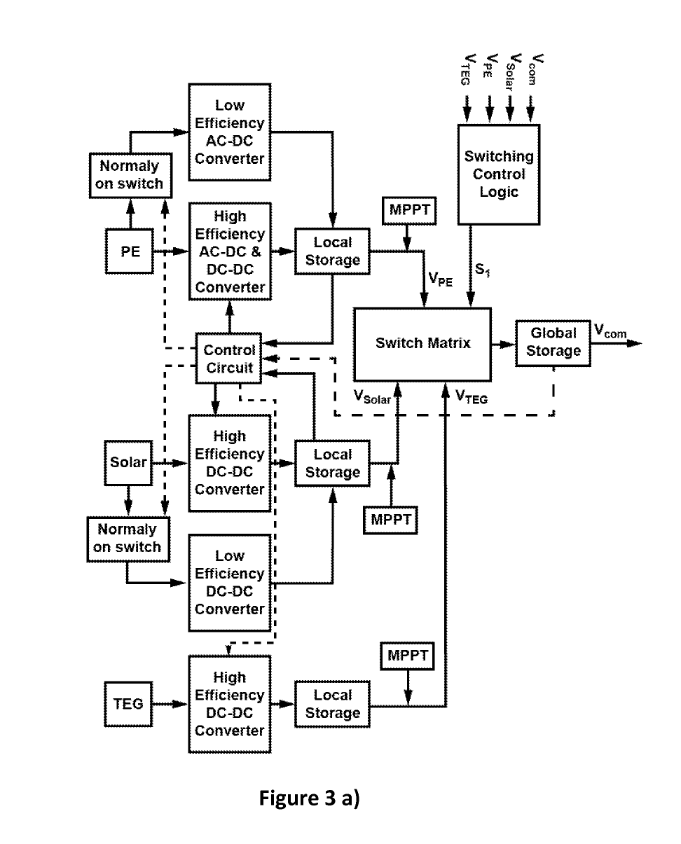

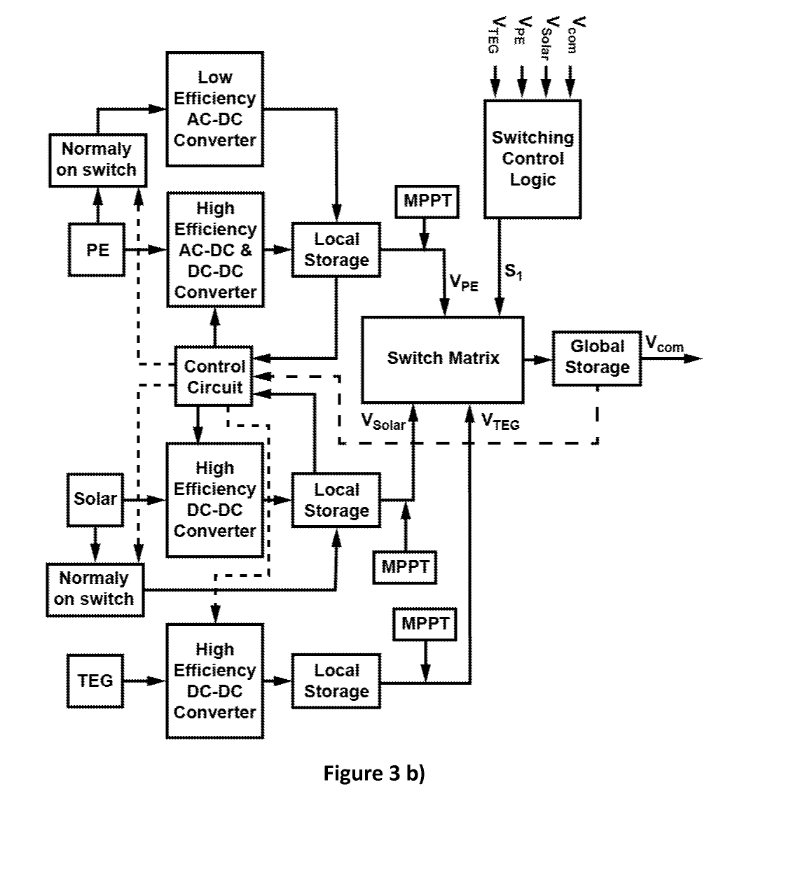

FIG. 3 illustrates the energy harvesting system 1 in accordance with one embodiment of the invention with both the passive startup circuit 1 and the active components (active circuit) of the system 1. The active circuit of the system 1 comprises all the components of the system 1 excluding the passive startup circuit 5. As illustrated in this figure, the system comprises high voltage output energy harvesters such as a vibration harvester 2 and a solar harvester 4 and low voltage output energy harvesters such as a thermal harvester 6. The system 1 further comprises normally on switches 8 & 12 electrically connected to the high voltage output energy harvesters, knowingly the vibration harvester 2 and the solar harvester 4 in this case.

The system 1 further comprises a low efficiency AC-DC converter 10 electrically connected to the high voltage output energy harvesters generating AC current, knowingly the vibration harvester 2 in this case. This electrical connection is made through a normally on switch 8 which enables such a connection when the startup circuit 5 is turned on and which disables this connection otherwise. In an embodiment of the invention and as illustrated in FIG. 3 a), the system further comprises at least one low efficiency DC-DC converter 14 electrically connected to the high voltage output energy harvesters generating DC current, knowingly the solar harvester 4 in this case. This electrical connection is made through a normally on switch 12 which enables such a connection at the startup phase (when the startup circuit 5 is turned on) and which disables this connection otherwise.

FIG. 3 b) shows an energy harvesting system 1 without a low efficiency DC-DC converter where the electrical energy generated by the solar harvester 4 is directed to the local storage unit 24 without prior conversion. In fact, in an embodiment of the invention, the electrical energy originating from the solar harvester 4 during startup needs not to be converted and therefore it is more efficient to have it stored directly in the local storage unit 24 without passing through a converter. According to this embodiment of the invention, the solar harvester 4 is directly connected to the local storage unit 24 without passing through a low efficiency DC-DC converter 14 as the electrical energy generated by the solar harvester 4 need not to be converted before storage. Therefore, depending on the application, the low efficiency DC-DC converter 14 might not be needed.

The system 1 further comprises at least one high efficiency AC-DC converter 16 electrically connected to both the low and high voltage output energy harvesters generating AC current, knowingly the vibration harvester 2 in this case. The system 1 further comprises at least one high efficiency DC-DC converter 18 & 20 electrically connected to both the low and high voltage output energy harvesters generating DC current, knowingly the solar harvester 4 and the thermal harvester 6 in this case.

The system 1 further comprises local storage units 22, 24 & 26 electrically connected to the electrical converters 10, 14, 16, 18 & 20 for storing the converted energy harvested from the energy harvesters 2, 4 & 6. The system allocates one separate local storage unit for each energy harvester available. This allows determining the amount of energy collected from each energy harvester separately. In this respect, in this example, a first local storage unit 22 is allocated to store the energy harvested by the vibration harvester 2. A first local storage unit 22 is electrically connected to the low efficiency AC-DC converter 10 and the high efficiency AC-DC converter 16 for receiving and storing the energy collected and converted originating from the vibration harvester 2 at both the startup phase and the normal operation phase respectively. A second local storage unit 24 is electrically connected to the low efficiency DC-DC converter 14 and the high efficiency DC-DC converter 18 for receiving and storing the energy collected and converted originating from the solar harvester 4 at both the startup phase and the normal operation phase respectively. A third local storage unit 26 is electrically connected to the high efficiency DC-DC converter 20 for receiving and storing the energy collected and converted originating from the thermal harvester 6 at the normal operation phase.

The system 1 further comprises a control circuit 28 for coordinating the operations of the passive startup circuit 5 and the active circuit of the system 1. The control circuit 28 is electrically connected to the normally on switches 8 & 12, the local storage units 22 & 24 associated with the high voltage output energy harvesters 2 & 4, the global storage unit 40 and to the high efficiency electrical converters 16, 18 & 20. The control circuit 28 monitors the amount of energy stored in the local storage units 22 & 24 and the global energy storage unit 40 collected from the high voltage output energy harvesters (knowingly the vibration harvester 2 and the solar harvester 4 in this example) during the startup phase and determines whether the collected energy is sufficient to operate the active circuit of the system 1.

This can be done by comparing the collected energy inside these local storage units 22 & 24 to a predefined threshold required for operating the active components for the system 1. If the amount of energy collected is superior to the predefined energy threshold, then the control circuit 28 turns off the passive startup circuit 5 and activates the active circuit. In this optics, the control circuit 28 turns off the normally on switches 8 & 12 and turns on the high efficiency electrical converters 16, 18 & 20.

When the active circuit is activated (through the activation of the high efficiency electrical converters 16, 18 & 20), all the energy harvesters 2, 4 & 6 are in operation. The high efficiency electrical converters 16, 18 & 20 are electrically connected to the local storage units 22, 24 & 26 respectively for storing the converted energy harvested from these energy harvesters 2, 4 & 6 respectively. The passive startup circuit 5 and the active circuit operate in the alternative and not simultaneously.

As mentioned above, in an embodiment of the invention, as illustrated in FIG. 3 a), the vibration harvester 2 and the solar harvester 4 are both connected to a low efficiency AC-DC and DC-DC converters 10 & 14 respectively. The generated energy is stored in local storages 22 & 24. Once the voltage on the local storage 22 & 24 reaches an enough level to run the active control circuit, the startup circuit is turned off through the “normally-on switch” 8 & 12. Then, the active control circuit runs the high efficiency converters 16, 18 & 20 for all energy harvesters in the system 1. In another embodiment of the invention, as illustrated in FIG. 3 b), the solar harvester 4 is directly connected to the local storage unit 24 without passing through a low efficiency DC-DC converter 14 as the electrical energy generated by the solar harvester 4 need not to be converted before storage.

The system 1 further comprises an energy combiner 25 comprising a switch matrix 30 and a switching control logic 32. The switch matrix 30 is electrically connected to the local storage units 22, 24 & 26, to the switching control logic 32 and to the global storage unit 40. The switch matrix 30 is adapted to receive the energy generated from the various energy harvesters 2, 4 & 6 after conversion and local storage in the local storage units 22, 24 & 26, to combine the energy received from these local storage units 22, 24 & 26 and to store the combined energy in a global energy storage unit 40 for subsequent use depending on the application.

For energy efficiency, this operation is however conducted in an energy selective manner based on the energy available by the different energy harvesters 2, 4 & 6. This “energy aware” scheme is to ensure that the generated energy is combined and delivered to the storage element 40 without (or with minimum) efficiency loss.

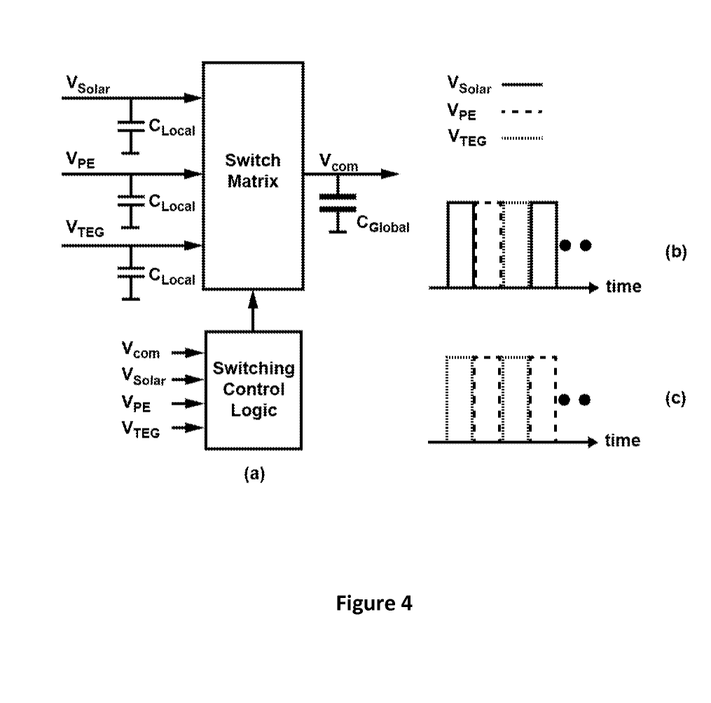

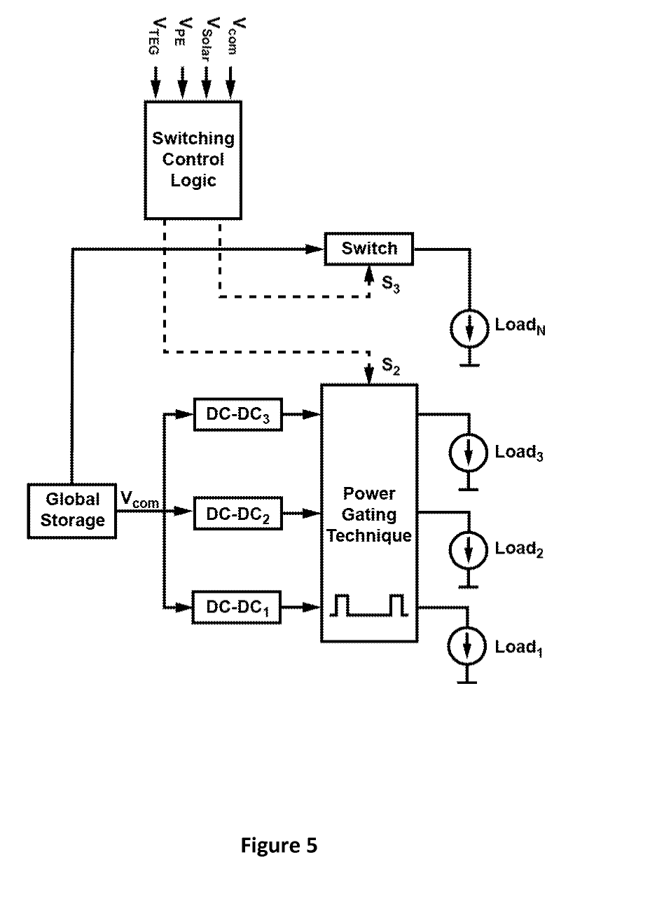

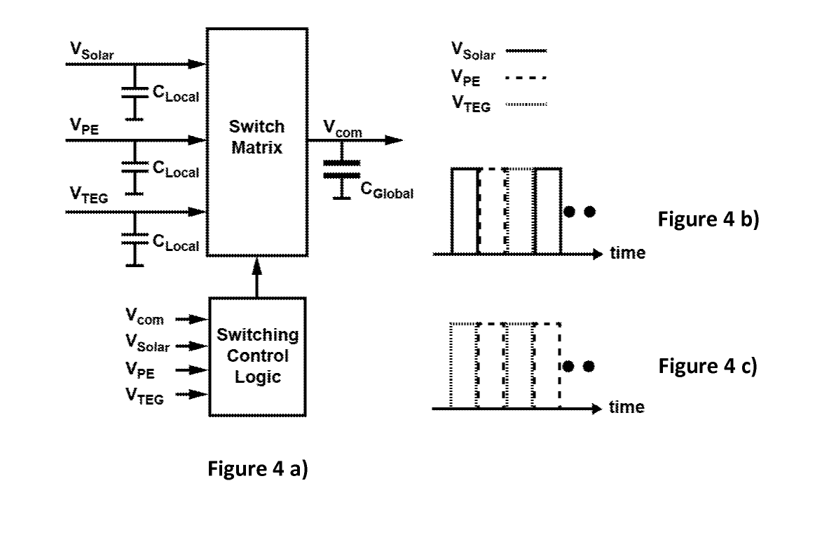

As illustrated in FIG. 4 a), the switch matrix 30 uses a time-multiplex scheme to select the energy source based on the harvester energy. In this respect, the energy combiner 25 comprises a switch matrix circuit 30 electrically connected to a switching control logic 32. The switching control logic 32 is electrically connected to the energy harvesters 2, 4 & 6 for sensing the input voltage of these energy harvesters 2, 4 & 6. Based on the input voltage from the different energy harvesters 2, 4 & 6, control signals are generated by the switching control logic 32 and sent to the switch matrix 30 for selecting and directing the harvester energy available into the global storage unit 40 for a specific time period. The switching control logic 32 is preferably further electrically connected to the loads 54, 56, 58 & 60 for determining the amount of energy required by the different loads and for generating the control signals taking into consideration the amount of energy required by the different loads in addition to the input voltage available by the different energy harvesters 2, 4 & 6. The energy combiner 25 further comprises a maximum power point tracking (MPPT) module 34 for extracting maximum power from the local storage units 22, 24 & 26.

For example, FIG. 4 b) shows a case when there is enough energy from all harvesters 2, 4 & 6. In this case, each harvester among the energy harvesters 2, 4 & 6 is given a time slot to direct its energy to the global storage unit 40. The switch matrix 30 will therefore allocate time slots for directing energy to the global energy storage unit 40 from the local storage units 22, 24 & 26 associated respectively to the vibration harvester 2, the solar harvester 4 and the thermal harvester 6.

In contrast, FIG. 4 c) shows an example where the solar harvester 4 doesn't have enough energy and only the vibration harvester 2 and the thermal harvester 6 are available. Since the solar harvester 4 doesn't have enough energy, only the vibration harvester 2 and the thermal harvester 6 are included in the time-multiplex scheme while leaving the solar in an idle mode. The switch matrix 30 will therefore allocate time slots for directing energy to the global energy storage unit 40 from the local storage units 22 and 26 associated respectively to the vibration harvester 2 and the thermal harvester 6.

It must be noted that this idle mode is not considered an energy loss since the solar harvester 4 is charging its local capacitor. This provides for an energy-aware combiner circuit 25 that harvests the energy from multiple sources without overloading the harvester source. In fact, the energy combiner 25 is adapted to direct energy only from energy harvesters among the energy harvesters 2, 4 & 6 from which energy is available. This technique leads in an efficient use of energy since it will avoid consuming energy by the energy combiner 25 while not harvesting any energy in return. Also, since the global storage unit 40 (for example a super capacitor or a battery) is connected to the harvesters 2, 4 & 6, this will avoid discharging the global capacitor 40 because otherwise the unavailable harvester would act as a ground. The switch matrix 30 is electrically connected to the global storage 40 for storing the harvested energy. The global storage unit 40 can be a super capacitor or a battery for example or any other energy storage element.

The energy harvesting system 1 further comprises a power management unit 45 that helps managing multiple loads 54, 56, 58 & 60. In order to be able to drive different loads with high peak currents, a power gating technique is utilized so that the global storage is charged during the sleep period and then walkup for a short period of time to do the job and then go back to sleep. Power gating technique provides many advantages, among others reducing the overall power consumption of the load by putting it in the sleep mode most of the time, providing the peak current required by the loads (mainly for the radio circuit). This will imply having a very low quiescent current for the converter circuits in order to increase the efficiency as well as very low leakage current and sleep current in the loads.

In fact, the energy from all harvesters 2, 4 & 6 is monitored by the switch control logic 32 and activates the harvester that has enough energy to be delivered to the loads 52, 54, 56, 58 & 60 by turning on its corresponding switch in the switch matrix module 30. The switch control logic 32 in collaboration with the switch matrix 30 uses a time-multiplexing scheme to give a time slot for each harvester based on its generated energy. The energy combiner 25 transfers the energy from local to global switches. The generated energy is stored during the idle mode of the harvesters 2, 4 & 6 in the local storage units 22, 24 & 26. The switch control module 30 controls the power gating module 50 and low power loads 52, 54, 56, 58 & 60. The power gating technique 50 is utilized with sleep mode mechanism. In an embodiment of the invention, the low current loads 52, 54, 56, 58 & 60 are powered directly without conversion circuit for low energy operation.

The energy harvester system 1 can be used with various applications such as biomedical devices, surveillance and smart structures applications. This will enable an autonomous electronics system that is once deployed can operate with no intervention and no maintenance for the expected lifetime of the system 1.

The power management unit 45 comprises DC-DC converters 42, 44 & 46 associated with the different loads 54, 56 & 58 in order to transform the energy directed from the global energy storage unit 40 into suitable form of energy for use by the different loads 54, 56 & 58. The loads 54, 56, 58 & 60 can comprise for example sensors, low power radio and microwatt DSP. This depends on the specific applications and can vary widely. There are as many DC-DC converters as needed for the transformation of energy into the suitable forms required by the loads.

The startup passive circuit 5 can be used in any energy harvesting system and is not limited for use with the energy harvesting system 1 described in the preferred embodiment of this invention. The energy combiner 25 can also be used in any energy harvesting system and is not limited to be used with the startup passive circuit 5 and the energy harvesting system 1 described in the preferred embodiment of this invention.

In an embodiment of the invention, the energy harvesting system 1 is adapted to be implemented using standard CMOS technologies. According to this embodiment, the system can handle input and output voltages from 20 mV to 5V. In an embodiment of the invention, the passive startup circuit 5 and the active circuit are implemented using a 0.35-um CMOS process.

Although the above description of the present invention has disclosed the features of the invention as applied to the preferred embodiment; additions, omissions and modifications applied to the details of the embodiment illustrated may be made by those skilled in the art without departing from the essential characteristic of the present invention.

Although the invention has been explained in relation to its preferred embodiment, it is to be understood that many other possible modifications and variations can be made without departing from the spirit and scope of the invention as herein described.

1. A self-powered energy harvesting system for harvesting electrical energy from the environment for feeding a load, the system comprising:
a first energy harvester for generating first electrical energy having a first input voltage from the environment;
a first local storage unit for storing the first electrical energy;
a passive startup circuit connected to the first energy harvester for harvesting and storing the first electrical energy inside the first local storage unit ;
a second energy harvester for generating second electrical energy having a second input voltage from the environment; and
an active circuit connected to the first local storage unit, to the second energy harvester and to the load for extracting and using the first electrical energy stored in the first local storage unit for harvesting, converting and directing the second electrical energy to the load, the second input voltage being insufficient for operating the active circuit.

2. The energy harvesting system as claimed in claim 1 further comprising:
a control circuit connected to the first local storage unit, to the passive startup circuit and to the active circuit for determining whether the first electrical energy stored inside the first local storage unit is sufficient for operating the active circuit and if it is the case, for deactivating the passive startup circuit and activating the active circuit.

3. The energy harvesting system as claimed in claim 2 wherein the passive startup circuit comprises:
a normally on switch connected to the first energy harvester and to the control circuit for switching off the passive startup circuit when instructed by the control circuit.

4. The energy harvesting system as claimed in claim 3 further comprising a second local storage unit for storing the second electrical energy after conversion.

5. The energy harvesting system as claimed in claim 4 wherein the first and second local storage units are electrical capacitors.

6. The energy harvesting system as claimed in claim 5 wherein the active circuit is further connected to the second energy harvester for harvesting, converting and storing the second electrical energy inside the second local storage unit when the startup circuit is switched off and for directing the second electrical energy to the load.

7. The energy harvesting system as claimed in claim 6 wherein the first energy harvester comprises a vibration harvester, and wherein the passive startup circuit further comprises a low efficiency AC-DC converter connected to the vibration harvester through the normally on switch for converting the first electrical energy originating from the vibration harvester before storage in the first local storage unit.

8. The energy harvesting system as claimed in claim 7, wherein the first energy harvester further comprises a solar harvester connected to the first local storage unit for storing the first electrical energy originating from the solar harvester in the first local storage unit without prior conversion .

9. The energy harvesting system as claimed in claim 8 wherein the second energy harvester comprises a thermal harvester and wherein the active circuit comprises a high-efficiency DC-DC converter connected to the second energy harvester and to the second local storage unit for converting the second electrical energy before storage.

10. The energy harvesting system as claimed in claim 1 further comprising:
a global storage unit; and
an energy combiner connected to the first local storage unit, to the second local storage unit, to the global storage unit and to the first and second energy harvesters for monitoring the first and second input voltages, for determining availability of the first and second electrical energy based on the monitoring, for extracting any available electrical energy among the first and second electrical energy from the first and second local storage units based on the energy availability determination, and for directing the extracted electrical energy for storage inside the global energy storage unit.

11. The energy harvesting system as claimed in claim 10 wherein the energy combiner comprises:
a switching control logic circuit connected to the energy harvesters for monitoring the first and second input voltages and for determining the availability of the first and second electrical energy, the monitoring and the energy availability determination comprising comparing the first and second input voltages to a threshold voltage and making the determination based on the comparison;
a switch matrix circuit connected to the switching control logic circuit, to the first and second local storage units and the global storage unit for receiving an indication of the available electrical energy among the first and second electrical energy from the switching control local circuit and for extracting and directing the available electrical energy from the first and second local storage units to the global energy storage unit on a time slot allocation basis as a function of the received indication.

12. The energy harvesting system as claimed in claim 11 wherein the global energy storage unit comprises a supercapacitor or a battery.

13. The energy harvesting system as claimed in claim 12 further comprising a power management unit for converting and directing the electrical energy stored in the global storage unit to the load.

14. The energy harvesting system as claimed in claim 13 wherein the load comprises a plurality of loads and the power management unit comprises a plurality of electrical DC-DC converters adapted for the plurality of loads and a power gating technique connected between the plurality of DC-DC converters and the plurality of loads.

15. A passive startup circuit for use with an energy harvesting system comprising an active circuit for harvesting electrical energy from a low power energy harvester generating a low voltage input voltage insufficient for an autonomous operation of the active circuit, the passive startup circuit comprising:
a high power energy harvester for generating first electrical energy from the environment;
a first local storage unit for storing the first electrical energy;
a control circuit connected to the first local storage unit, to the passive startup circuit and to the active circuit for determining whether the first electrical energy stored inside the first local storage unit is sufficient for operating the active circuit and if it is the case, for deactivating the passive startup circuit and activating the active circuit; and
a normally on switch connected to the first energy harvester and to the control circuit for switching off the passive startup circuit when instructed by the control circuit.

16. The passive startup circuit as claimed in claim 15 wherein the first local storage unit comprises an electrical capacitor.

17. The passive startup circuit as claimed in claim 16 wherein the high power energy harvester comprises a vibration harvester and wherein the passive startup circuit further comprises a low efficiency AC-DC converter connected to the vibration harvester through the normally on switch for converting the first electrical energy originating from the vibration harvester before storage in the first local storage unit.

18. The passive startup circuit as claimed in claim 17, wherein the high power energy harvester further comprises a solar harvester connected to the first local storage unit for storing the first electrical energy originating from the solar harvester in the first local storage unit without prior conversion

19. The passive startup circuit as claimed in claim 18 wherein the low power energy harvester comprises a thermal harvester.

20. An energy combiner for use with an energy harvesting system harvesting electrical energy using at least two energy harvesters, a first energy harvester having a first input voltage generating a first electrical energy and a second energy harvester having a second input voltage generating a second electrical energy, wherein:
the energy combiner is adapted to be connected to the first and second energy harvesters for monitoring the first and second input voltages, for determining availability of the first and second electrical energy based on the monitoring, for harvesting any available electrical energy among the first and second electrical energy selectively based on the energy availability determination, and for storing the harvested electrical energy inside a global energy storage unit for subsequent use by the energy harvesting system.

21. The energy combiner as claimed in claim 20 comprising:
a switching control logic circuit connected to the energy harvesters for monitoring the first and second input voltages and for determining the availability of the first and second electrical energy, the monitoring and the energy availability determination comprising comparing the first and second input voltages to a threshold voltage and making the determination based on the comparison;
a switch matrix circuit connected to the switching control logic circuit, to the first and second electrical energy for receiving an indication of the available electrical energy among the first and second electrical energy from the switching control logic circuit and for harvesting and directing the available electrical energy to the global energy storage unit on a time slot allocation basis as a function of the received indication.
